(19) United States
(12) Patent Application Publication
(10) Pub. No.: US 2025/0155561 A1
(43) Pub. Date: May 15, 2025

(54) LIDAR AND CALIBRATION METHOD THEREOF

(71) Applicant: Wuhan VanJee Optoelectronic Technology Co., Ltd., Wuhan (CN)

(72) Inventors: Yi LI, Wuhan (CN); Yang XU, Wuhan (CN); Chuhuan FENG, Wuhan (CN); Yongqiang DENG, Wuhan (CN)

(73) Assignee: Wuhan VanJee Optoelectronic Technology Co., Ltd., Wuhan (CN)

(21) Appl. No.: 19/006,253

(22) Filed: Dec. 31, 2024

Related U.S. Application Data
(63) Continuation of application No. PCT/CN2023/137557, filed on Dec. 8, 2023.

(30) Foreign Application Priority Data
Dec. 30, 2022 (CN) 202211724524.6

(51) Int. Cl. G01S 7/497; G01S 7/481; G01S 7/4911

(52) U.S. Cl. CPC G01S 7/497; G01S 7/4814; G01S 7/4911

(57) ABSTRACT

A lidar and a calibration method thereof. In the lidar, a phase-modulated emitted laser light sub-beam is transmitted, by a transmitting antenna in a phased-array antenna array, to a detection area, and, an echo signal is received by a receiving antenna in the phased-array antenna array; and an antenna modification structure is utilized to adjust a characteristic parameter of the transmitting antenna and/or a characteristic parameter of the receiving antenna, a position of a corresponding light spot is changed by adjusting the characteristic parameter of the antenna, so that a deviation angle between a light spot of at least one transmitting antenna and a light spot of at least one receiving antenna is reduced and a distance between a center of the light spot of the transmitting antenna and a center of the light spot of the receiving antenna is decreased.

### CROSS-REFERENCE TO RELATED APPLICATION

This application is a continuation of International Patent Application of PCT application serial No. PCT/CN2023/137557, filed on Dec. 8, 2023, which claims the benefit of priority from China Application No. 202211724524.6, filed on Dec. 30, 2022. The entirety of each of the above mentioned patent applications is hereby incorporated by reference herein and made a part of this specification.

### TECHNICAL FIELD

The present application belongs to a field of lidar technology, and in particular relates to a lidar and a calibration method thereof.

### BACKGROUND

The concept of phased-array lidar has been proposed long time ago, and various design solutions are constantly being launched. At present, phased-array lidar chips generally use SOI (Silicon-On-Insulator) materials as substrates and are used to fabricate various on-chip structures by utilizing the good properties of silicon, thereby achieving the basic functions of a lidar. Specifically, an emitted light beam provided by a laser light source is coupled to an optical chip through an input coupler; and after beam splitting and phase modulation are performed on the optical chip, the emitted light beam is transmitted to a detection area by a transmitting antenna on the optical chip, and an echo signal reflected by an object in the detection area is received by a receiving antenna on the optical chip. In an ideal state, the centers of light spots of the transmitting antenna and the receiving antenna in the same phased-array almost coincide, and target object information can be obtained by using the emitted beam and the echo signal. It can be understood that the transmitting antenna transmits a laser beam to the detection area, and a transmitting light spot of the transmitting antenna (hereinafter referred to as the light spot of the transmitting antenna) thus can be formed in the detection area; for the receiving antenna, usually there is no emitted light spots; but based on the principle of reversible optical path in optical antennas, the receiving antenna can also be used as a transmitting antenna, at this time, a light spot of the transmitting antenna (i.e. the receiving antenna used for transmission) can be regarded as a receiving light spot of the receiving antenna (hereinafter referred to as the light spot of the receiving antenna).

However, due to the limitation of the manufacturing process, such as inaccurate waveguide width, rough and non perpendicular waveguide edges, and poor wafer surface flatness caused by etching accuracy, parameters of the transmitting antenna and the receiving antenna are actually different. Therefore, in the practical application of an OPA (optical phased array) lidar, a light beam deflection angle of the light spot of the transmitting antenna is also different from that of the light spot of the receiving antenna, resulting in a certain degree of mismatch of the spots and inability to guarantee the best ranging performance of the lidar system.

### TECHNICAL PROBLEM

The purpose of the present application is to provide a lidar and a calibration method thereof, with the aim of solving the problem of reduced ranging performance of the lidar system caused by the process in the prior art.

### SUMMARY

The technical solutions adopted by embodiments of the present application is as follows.

The present application provides a lidar, including:
a light source, configured to provide an emitted laser light beam;
a coupler, optically connected with the light source, and configured to couple the emitted laser light beam to an optical chip;
a beam splitter, optically connected with the coupler, and configured to split the emitted laser light beam to form an emitted laser light sub-beam;
a phase shifter, optically connected with the beam splitter, and configured to perform phase modulation to the emitted laser light sub-beam;
a phased-array antenna array, including at least one transmitting antenna and at least one receiving antenna, where the transmitting antenna and the receiving antenna are optically connected with the phase shifter one by one, the transmitting antenna is configured to transmit a phase-modulated emitted laser light sub-beam to a detection area, the receiving antenna is configured to receive an echo signal, the echo signal is a light beam reflected by an object in the detection area after the object receives the emitted laser light sub-beam; and
an antenna modification structure, provided corresponding to the phased-array antenna array, and configured to adjust a characteristic parameter of the transmitting antenna and/or a characteristic parameter of the receiving antenna, so as to reduce a deviation angle between a transmitting light spot of the at least one transmitting antenna and a receiving light spot of the at least one receiving antenna;
where the deviation angle is a difference between light beam deflection angles respectively corresponding to any two light spots of the transmitting light spot and the receiving light spot, and a light beam deflection angle is an angle formed between a light beam corresponding to a light spot and a plane of the optical chip.

In an embodiment, after the characteristic parameter of the transmitting antenna and/or the characteristic parameter of the receiving antenna is adjusted, the deviation angle between the transmitting light spot of the transmitting antenna and the receiving light spot of the receiving antenna is less than or equal to a preset threshold.

In an embodiment, the preset threshold is not greater than 0.5°.

In an embodiment, the antenna modification structure is provided to be matched with the transmitting antenna;
the characteristic parameter of the transmitting antenna is adjusted by the antenna modification structure, so as to reduce the deviation angle between the transmitting light spot of the adjusted transmitting antenna and the receiving light spot of the at least one receiving antenna.

In an embodiment, the antenna modification structure is provided to be matched with the receiving antenna;
the characteristic parameter of the receiving antenna is adjusted by the antenna modification structure, so as to reduce the deviation angle between the receiving light spot of the adjusted receiving antenna and the transmitting light spot of the at least one transmitting antenna.

In an embodiment, each transmitting antenna and each receiving antenna are respectively provided with one antenna modification structure;
a transmitting light spot of one transmitting antenna or a receiving light spot of one receiving antenna in the phased-array antenna array is used as a reference light spot, characteristic parameters of other receiving antennas and/or other transmitting antennas are adjusted by the antenna modification structure, so as to reduce a deviation angle between a receiving light spot of an adjusted receiving antenna and/or a transmitting light spot of an adjusted transmitting antenna and the reference light spot.

In an embodiment, each transmitting antenna and each receiving antenna are respectively provided with one antenna modification structure;
a light spot corresponding to a greatest light beam deflection angle is used as a reference light spot, characteristic parameters of transmitting antennas and/or receiving antennas corresponding to other light spots are adjusted by the antenna modification structure, so as to reduce a deviation angle between a light spot of an adjusted transmitting antenna and/or an adjusted receiving antenna and the reference light spot; or
a light spot corresponding to a smallest light beam deflection angle is used as a reference light spot, characteristic parameters of transmitting antennas and/or receiving antennas corresponding to other light spots are adjusted by the antenna modification structure, so as to reduce a deviation angle between a light spot of an adjusted receiving antenna and/or an adjusted transmitting antenna and the reference light spot.

In an embodiment, the antenna modification structure is any one of an electro-optic modification structure, a thermo-optic modification structure, an acousto-optic modification structure, and a micro-electro-mechanical modification structure.

In an embodiment, each transmitting antenna and each receiving antenna are respectively provided with one antenna modification structure;
a transmitting antenna and/or a receiving antenna which needs to be adjusted is determined from the transmitting antenna and the receiving antenna, the thermo-optic modification structure is utilized to adjust a characteristic parameter of a determined transmitting antenna and/or a characteristic parameter of a determined receiving antenna.

In an embodiment, the antenna modification structure is located at bottom or top of the phased-array antenna array.

In an embodiment, when the phased-array antenna array includes a plurality of receiving antennas, the plurality of receiving antennas are distributed on both sides of the transmitting antenna.

In an embodiment, the lidar further includes a lens module, where the lens module is located at a light output side of the phased-array antenna array, and is configured to perform collimation and beam expansion to the emitted laser light sub-beam of the transmitting antenna and perform converging to the echo signal.

Based on the same application concept, the present application also provides a calibration method of a lidar, including:
providing an emitted laser light beam, and coupling the emitted laser light beam to an optical chip;
splitting the emitted laser light beam to form an emitted laser light sub-beam;
performing phase modulation to the emitted laser light sub-beam, and providing a phase-modulated emitted laser light sub-beam to a phased-array antenna array;
transmitting, by a transmitting antenna in the phased-array antenna array, the phase-modulated emitted laser light sub-beam to a detection area; and, receiving, by a receiving antenna in the phased-array antenna array, an echo signal, where the echo signal is a light beam reflected by an object in the detection area after the object receives the emitted laser light sub-beam; and
utilizing an antenna modification structure to adjust a characteristic parameter of the transmitting antenna and/or a characteristic parameter of the receiving antenna, so as to reduce a deviation angle between a transmitting light spot of at least one transmitting antenna and a receiving light spot of at least one receiving antenna;
where the deviation angle is a difference between light beam deflection angles respectively corresponding to any two light spots of the transmitting light spot and the receiving light spot, and a light beam deflection angle is an angle formed between a light beam corresponding to a light spot and a plane of the optical chip.

In an embodiment, the method further includes: when the antenna modification structure is provided to be matched with the transmitting antenna, utilizing the antenna modification structure to adjust the characteristic parameter of the transmitting antenna, so as to reduce the deviation angle between the transmitting light spot of the adjusted transmitting antenna and the receiving light spot of the at least one receiving antenna; or,
when the antenna modification structure is provided to be matched with the receiving antenna, utilizing the antenna modification structure to adjust the characteristic parameter of the receiving antenna, so as to reduce the deviation angle between the receiving light spot of the adjusted receiving antenna and the transmitting light spot of the at least one transmitting antenna; or,
when each transmitting antenna and each receiving antenna are respectively provided with one antenna modification structure, using a transmitting light spot of one transmitting antenna or a receiving light spot of one receiving antenna in the phased-array antenna array as a reference light spot, utilizing the antenna modification structure to adjust characteristic parameters of other transmitting antennas and/or other receiving antennas, so as to reduce a deviation angle between a light spot of an adjusted transmitting antenna and/or an adjusted receiving antenna and the reference light spot.

In an embodiment, each transmitting antenna and each receiving antenna are respectively provided with one antenna modification structure, the method further including: using a light spot corresponding to a greatest light beam deflection angle as a reference light spot, adjusting, by the antenna modification structure, characteristic parameters of transmitting antennas and/or receiving antennas corresponding to other light spots, so as to reduce a deviation angle between a light spot of an adjusted transmitting antenna and/or an adjusted receiving antenna and the reference light spot; or using a light spot corresponding to a smallest light beam deflection angle as a reference light spot, adjusting, by the antenna modification structure, characteristic parameters of transmitting antennas and/or receiving antennas corresponding to other light spots, so as to reduce a deviation angle between a light spot of an adjusted transmitting antenna and/or an adjusted receiving antenna and the reference light spot.

In an embodiment, the antenna modification structure may be any one of an electro-optic modification structure, a thermo-optic modification structure, an acousto-optic modification structure, and a micro-electro-mechanical modification structure.

In an embodiment, each transmitting antenna and each receiving antenna are respectively provided with one antenna modification structure, the utilizing an antenna modification structure to adjust a characteristic parameter of the transmitting antenna and/or a characteristic parameter of the receiving antenna includes: determining a transmitting antenna and/or a receiving antenna which needs to be adjusted from the transmitting antenna and the receiving antenna according to the light beam deflection angle corresponding to the light spot of the transmitting antenna and the light beam deflection angle corresponding to the light spot of the receiving antenna;
utilizing the thermo-optic modification structure to adjust a characteristic parameter of a determined transmitting antenna and/or a characteristic parameter of a determined receiving antenna.

### BENEFICIAL EFFECTS

In summary, the embodiments of the present application provide a lidar and a calibration method thereof. The lidar includes a light source, a coupler, a beam splitter, a phase shifter, a phased-array antenna array and an antenna modification structure. A phase-modulated emitted laser light sub-beam is transmitted, by a transmitting antenna in the phased-array antenna array, to a detection area, and, an echo signal is received by a receiving antenna in the phased-array antenna array; and an antenna modification structure is utilized to adjust a characteristic parameter of the transmitting antenna and/or a characteristic parameter of the receiving antenna, a position of a corresponding light spot is changed by adjusting the characteristic parameter of the antenna, so that a deviation angle between a light spot of at least one transmitting antenna and a light spot of at least one receiving antenna is reduced and a distance between a center of the light spot of the transmitting antenna and a center of the light spot of the receiving antenna is decreased, so as to overcome a certain degree of mismatch of the light spots caused by the characteristic parameter of the transmitting antenna being different from the characteristic parameter of the receiving antenna due to manufacturing process, thereby improving the ranging performance of the lidar.

### BRIEF DESCRIPTION OF THE DRAWINGS

In order to illustrate the technical solutions of embodiments of the present application more clearly, the drawings that need to be used in the description of the embodiments of the present application or in the description of the prior arts will be briefly introduced in the following. Obviously, the drawings in the following description are intended for some embodiments of the present application. For those of ordinary skill in the art, other drawings can be obtained according to these drawings without any creative effort.

FIG. 1 is a schematic structure diagram of a lidar according to an embodiment of the present application.

FIG. 2 is a schematic diagram of effect of utilizing an antenna modification structure to perform modification according to an embodiment of the present application.

FIG. 3 is another schematic diagram of effect of utilizing an antenna modification structure to perform modification according to an embodiment of the present application.

FIG. 4 is another schematic diagram of effect of utilizing an antenna modification structure to perform modification according to an embodiment of the present application.

FIG. 5 is a schematic structure diagram of a phased-array antenna array according to an embodiment of the present application.

FIG. 6 is a schematic structure diagram of another phased-array antenna array according to an embodiment of the present application.

FIG. 7 is a schematic structure diagram of another phased-array antenna array according to an embodiment of the present application.

FIG. 8 is a schematic structure diagram of a lidar including a lens module according to an embodiment of the present application.

### BRIEF DESCRIPTION OF REFERENCE SIGNS

Light source—110; coupler—120; beam splitter—130; phase shifter—140; phased-array antenna array—150; antenna modification structure—160; lens module—170.

### DETAILED DESCRIPTION OF DISCLOSURED EMBODIMENTS

In the below, embodiments of the present application will be described in detail, examples of the embodiments are shown in the drawings, where the same or similar numbering throughout indicates the same or similar elements or elements with the same or similar functions. The embodiments described below with reference to the drawings are exemplary and intended to explain the present application, and should not be understood as the limitation to the present application.

In the description of the present application, it should be understood that directional or positional relationships indicated by terms, such as “length”, “width”, “above”, “below”, “front”, “back”, “left”, “right”, “vertical”, “horizontal”, “top”, “bottom”, “inside” and “outside”, are directional or positional relationships shown based on the drawings, which are only for the convenience of describing the present application and simplifying the description, and are not indications or implications of the device or component referred to must having a specific orientation, or being constructed and operated in a specific orientation, and therefore cannot be understood as a limitation to the present application.

In addition, terms “first” and “second” are only used for descriptive purposes and cannot be understood as indicating or implying relative importance or implicitly indicating the number of technical features. Thus, the features limited with “first” and “second” may explicitly or implicitly include one or more of these features. In the description of the present application, the meaning of “a plurality of” is two or more, unless otherwise specifically and explicitly limited.

In the present application, unless otherwise explicitly specified and limited, terms “installation”, “linking”, “connection”, “fixation”, etc., should be broadly understood, for example, they can be fixed connection, detachable connection, or integrated; they can be mechanical connection or electrical connection; they can be directly linked or indirectly linked through an intermediate medium, and they can be a connection within two components or an interaction relationship between two components. For those ordinary skilled in the art, specific meanings of the above terms in the present application can be understood according to specific situations.

In order to make the purpose, technical solution, and advantages of the present application clearer and more explicit, the following will provide further detailed description of the present application in conjunction with drawings and embodiments.

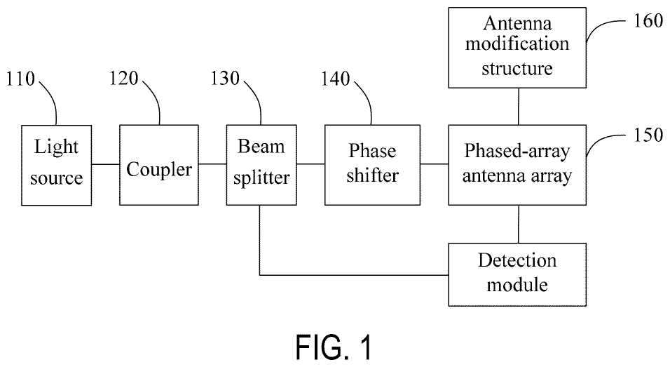

Please refer to FIG. 1, in an embodiment of the present application, a lidar is provided, including: a light source 110, a coupler 120, a beam splitter 130, a phase shifter 140, a phased-array antenna array 150, and an antenna modification structure 160.

Specifically, the light source 110 is configured to provide an emitted laser light beam. The coupler 120 is optically connected with the light source 110 and is configured to couple the emitted laser light beam to an optical chip. The beam splitter 130 is optically connected with the coupler 120 and is configured to split the emitted laser light beam to form emitted laser light sub-beams. The phase shifter 140 is optically connected with the beam splitter 130 and is configured to perform phase modulation to the emitted laser light sub-beams. The phased-array antenna array 150 includes at least one transmitting antenna TX and at least one receiving antenna RX, where the transmitting antenna(s) and the receiving antenna(s) are optically connected with the phase shifter one by one, the transmitting antenna TX is configured to transmit a phase-modulated emitted laser light sub-beam to a detection area, and the receiving antenna RX is configured to receive an echo signal, where the echo signal is a light beam reflected by an object in the detection area after the object receives the emitted laser light sub-beam. The antenna modification structure 160 is provided corresponding to the phased-array antenna array 150 and is configured to adjust characteristic parameters of the transmitting antenna(s) and/or characteristic parameters of the receiving antenna(s), so as to reduce a deviation angle between a transmitting light spot of the at least one transmitting antenna and a receiving light spot of the at least one receiving antenna; where the deviation angle is a difference between light beam deflection angles respectively corresponding to any two light spots of the transmitting light spot and the receiving light spot, and a light beam deflection angle is an angle formed between a light beam corresponding to a light spot and a plane of the optical chip.

It can be understood that, in this embodiment, the phased-array antenna array 150 includes at least one transmitting antenna TX and at least one receiving antenna RX, to implement transmission and reception of a light signal. The coupler 120, the beam splitter 130, the phase shifter 140, the phased-array antenna array 150 and the antenna modification structure 160 can be all integrated on the optical chip, where the coupler 120, the beam splitter 130, the phase shifter 140 and the phased-array antenna array 150 are connected in sequence through a wave guide, and the antenna modification structure 160 is provided corresponding to the phased-array antenna array 150. Specifically, the structures of the above respective components can be integrated onto a standard substrate compatible with CMOS (Complementary Metal Oxide Semiconductor) technology, namely an SOI substrate. The SOI substrate includes a substrate silicon layer, a buried oxygen layer, and a top silicon layer from bottom to top. The coupler 120, the beam splitter 130, and the phased-array antenna array 150 are formed on the top silicon layer of the SOI substrate. There are no limitations on material and thickness of each layer of the SOI substrate in this embodiment. In practical processes, material and thickness of each layer can be customized according to different requirements; or, SOI substrate products with a conventional standard CMOS process can be used, with the thickness of the substrate silicon layer being 400-800 μm, the thickness of the top silicon layer being about 220 nm, and the buried oxide layer being a silicon dioxide layer with a thickness of about 2 μm.

During a working process of the lidar shown in FIG. 1, the light source 110 is utilized to generate the emitted laser light beam, and the emitted laser light beam is provided to the coupler 120 and is coupled, by the coupler 120, to the optical chip; secondly, after beam splitting and phase modulation are performed in sequence to the emitted laser light beam, phase-modulated emitted laser light sub-beams are transmitted, by the transmitting antenna(s) in the phased-array antenna array 150, to a detection area, and, an echo signal/echo signals is/are received by the receiving antenna(s) in the phased-array antenna array 150; and at the same time, according to positions of a light spot/light spots of the transmitting antenna(s) and a light spot/light spots of the receiving antenna(s), the antenna modification structure 160 is utilized to adjust characteristic parameters of the transmitting antenna(s) and/or characteristic parameters of the receiving antenna(s), so that a deviation angle between a light spot of at least one transmitting antenna and a light spot of the at least one receiving antenna is reduced, ensuring that the light spot(s) of the transmitting antenna(s) and the light spot(s) of the receiving antenna(s) coincide as much as possible, so as to solve the mismatch of the light spots caused by the characteristic parameters of the transmitting antenna(s) being different from the characteristic parameters of the receiving antenna(s) due to the manufacturing process, thereby improving the ranging performance of the lidar. From the above content, it can also be acknowledged that the present application changes a position of a light spot through heating an antenna, so as to make the light spot(s) of the transmitting antenna(s) and the light spot(s) of the receiving antenna(s) coincide as much as possible, which can improve detection accuracy. Moreover, compared to a technical solution that improve light spot quality of a single antenna by forming a two-dimensional temperature gradient in one antenna unit so as to improve detection accuracy in the existing related arts, the present application does not require precise separate-zone-heating to a single antenna through an antenna modification structure, which makes the heating operation easier to implement and the heating control cost lower.

In an embodiment, after the characteristic parameter of the transmitting antenna and/or the characteristic parameter of the receiving antenna is adjusted, the deviation angle between the light spot of the transmitting antenna and the light spot of the receiving antenna is less than or equal to a preset threshold. It can be understood that the emitted laser light sub-beams converge in a far field to form a small spot. In order to ensure that an object within a detection field can be detected, that is, to ensure that the object is located in both a spot area of the transmitting antenna and a spot area of the receiving antenna, the deviation angle between the two spot areas needs to be controlled within a certain range. In this embodiment, the characteristic parameters of the transmitting antenna(s) and/or the characteristic parameters of the receiving antenna(s) are adjusted through the antenna modification structure 160, for example, a refractive index, carrier concentration, an antenna grating period, a duty cycle, etc. of the transmitting antenna and/or the receiving antenna are adjusted, so that the deviation angle between the light spot of the transmitting antenna and the light spot of the receiving antenna is less than or equal to the preset threshold, which can ensure the ranging performance of the adjusted antenna.

In an embodiment, the preset threshold is not greater than 0.5°. It can be understood that when the deviation angle between the light spot of the transmitting antenna and the light spot of the receiving antenna is greater than 0.5°, an object with an ordinary size may not be detected. Therefore, to ensure that an object in the far field can be scanned, the preset threshold needs to be controlled within 0.5°. In an embodiment, the preset threshold can be set to no more than 0.1° to maximize the accuracy of detection and ranging performance as much as possible.

In an embodiment, the light source 110 configured to provide the emitted laser light beam may include any one of a semiconductor laser, a fiber laser, a diode pump solid state laser, etc.; among them, due to the advantages of small size, light weight, high efficiency, low energy consumption, long lifespan, and high absorption of metal to semiconductor lasers, the semiconductor laser is generally used to provide the emitted laser light beam in practical applications, which can be specifically an edge emitting laser or a vertical cavity surface emitter. In this embodiment, the emitted laser light beam is a frequency modulated continuous wave light beam to achieve long-distance and high-precision scanning; in addition, the emitted laser light beam can also be a pulse signal, and there are no limitations on the type of laser or the type of optical signal in this embodiment.

In an embodiment, the coupler 120 is an input coupler, specifically, may be specifically an edge coupler, a Y-branch coupler, a directional coupler or a grating coupler. An input terminal of the coupler 120 is connected with the laser through an optical fiber, and receives the emitted laser light beam provided by the laser; an output terminal of the coupler 120 is connected with the beam splitter 130 through a wave guide, and provides the emitted laser light beam to the beam splitter 130. In addition, the input coupler can be integrated on the optical chip, or can be provided separately.

In an embodiment, the beam splitter 130 is optically connected with the coupler 120 and is configured to split the emitted laser light beam to form emitted laser light sub-beams. Specifically, the beam splitter 130 may be an edge coupler, a Y-branch coupler, a directional coupler or a multi-mode interference coupler.

In an embodiment, the phase shifter 140 is optically connected with the beam splitter 130 and is configured to perform phase modulation to the emitted laser light sub-beams. Specifically, before transmitting the emitted laser light sub-beam(s) to the detection area via the transmitting antenna(s), electro-optic phase shifter(s) can be utilized to perform phase modulation to the emitted laser light sub-beam(s), so as to achieve fast scanning of light spot(s). And, during a process of receiving the echo signal(s), a thermo-optic phase shifter with low optical loss is utilized to perform phase modulation to a received echo signal, which can reduce optical loss effectively and achieve efficient reception of the echo signal. In addition, in some other embodiments, only electro-optic phase shifter(s) or thermo-optic phase shifter(s) can be used to implement phase modulation of the emitted laser light sub-beam(s) and the echo signal(s).

The phased-array antenna array 150 includes at least one transmitting antenna and at least one receiving antenna, where the transmitting antenna(s) and the receiving antenna(s) are optically connected with the phase shifter one by one, the transmitting antenna is configured to transmit the phase-modulated emitted laser light sub-beam(s) to a detection area, the receiving antenna is configured to receive an echo signal, the echo signal is a light beam reflected by an object in the detection area after the object receives the emitted laser light sub-beam. Therefore, in the specific structure of the lidar, the purpose of reducing the deviation angle between the light spot of the transmitting antenna and the light spot of the receiving antenna can be achieved by adjusting the characteristic parameter of the transmitting antenna or the characteristic parameter of the receiving antenna respectively, or synchronously adjusting the characteristic parameter of the transmitting antenna and the characteristic parameter of the receiving antenna.

It can be understood that in order to improve the problem that it is impossible to achieve accurate detection of targets in the detection area because of large deviation angle between the light spot of the transmitting antenna and the light spot of the receiving antenna due to the influence of manufacturing process accuracy, a position of the light spot of the transmitting antenna and a position of the light spot of the receiving antenna can be individually modified by the antenna modification structure 160, or a position of the light spot of the transmitting antenna and a position of the light spot of the receiving antenna can be synchronously adjusted by the antenna modification structure 160, so as to reduce the deviation angle between the light spot of the transmitting antenna and the light spot of the receiving antenna.

In an embodiment, the antenna modification structure 160 is provided to be matched with the transmitting antenna TX; the characteristic parameter of the transmitting antenna is adjusted by the antenna modification structure 160, so as to reduce a deviation angle between a light spot of a adjusted transmitting antenna and the light spot of the at least one receiving antenna.

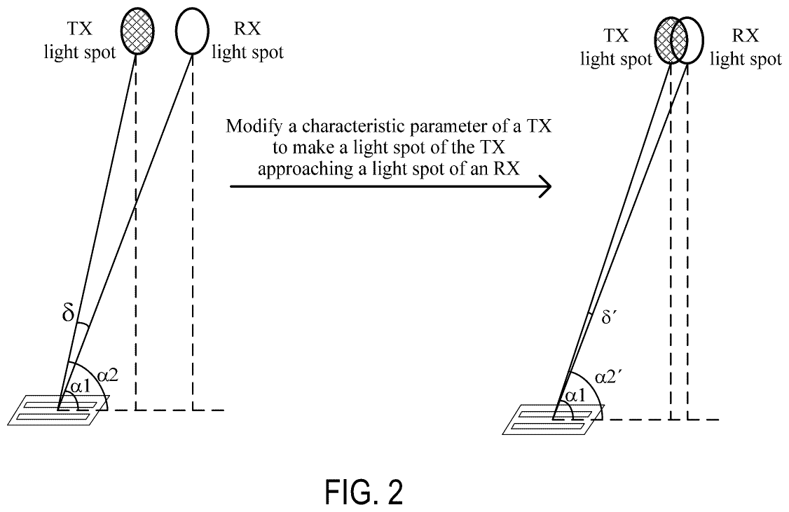

Please refer to FIG. 2, the phased-array antenna array 150 in this embodiment may include one transmitting antenna TX and one receiving antenna RX. Due to the influence of the manufacturing process accuracy, the light beam deflection corresponding to the light spot of the receiving antenna is α1, and the light beam deflection angle corresponding to the light spot of the transmitting antenna is α2, where α1<α2; there may be a large deviation angle δ between the light spot of the transmitting antenna and the light spot of the receiving antenna, where δ=|α1−α2|. There is no overlapping area between these two light spots, which makes it impossible to receive the corresponding echo signal and results in lower ranging performance. In order to improve this problem, the transmitting antenna is provided to be matched with the antenna modification structure 160 in this embodiment, therefore, the characteristic parameter of the transmitting antenna can be adjusted through the antenna modification structure 160, such as changing a refractive index of the transmitting antenna, so as to change the light beam deflection angle of the transmitting laser light sub-beam, thereby changing the position of the light spot of the transmitting antenna and making the light spot of the transmitting antenna approach the light spot of the receiving antenna, thereby reducing the deviation angle between the light spot of the transmitting antenna and the light spot of the receiving antenna. In this embodiment, a light beam deflection angle corresponding to a light spot of an adjusted transmitting antenna is α2′, and the deviation angle becomes δ′ at this time, δ=|α1−α2′|, and δ′ is less than δ.

It should be noted that due to the small size of the phased-array antenna array 150, it can be approximately assumed that a transmitting position of the emitted laser light sub-beam is the same as a position where a corresponding echo signal reaches the surface of the phased-array antenna array 150. That is, the light spot of the transmitting antenna and the light spot of the receiving antenna are formed based on light beams emitted from the same light emitting point.

In an embodiment, the antenna modification structure 160 is provided to be matched with the receiving antenna; the characteristic parameter of the receiving antenna is adjusted by the antenna modification structure 160, so as to reduce a deviation angle between a light spot of an adjusted receiving antenna and the light spot of the at least one transmitting antenna.

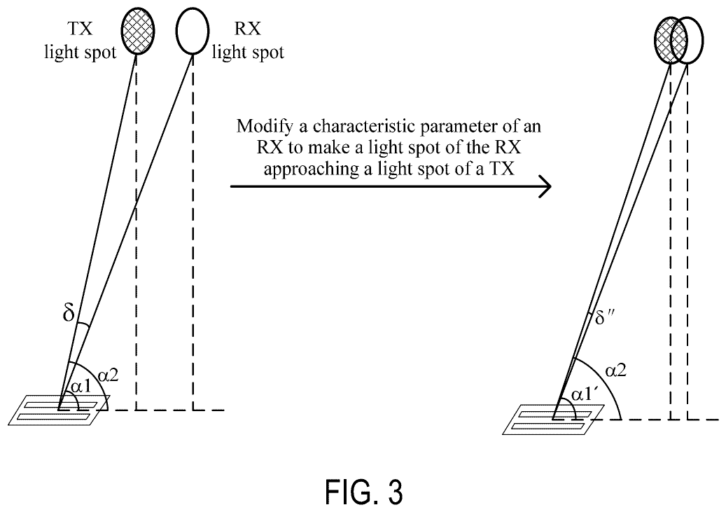

Please refer to FIG. 3, the phased-array antenna array 150 in this embodiment may include one transmitting antenna TX and one receiving antenna RX. Due to the influence of the manufacturing process accuracy, the light beam deflection corresponding to the light spot of the receiving antenna is α1, and the light beam deflection angle corresponding to the light spot of the transmitting antenna is α2, where α1<α2; there may be a large deviation angle δ between the light spot of the transmitting antenna and the light spot of the receiving antenna, where δ=|α1−α2|. There is no overlapping area between these two light spots, which makes it impossible to receive the corresponding echo signal and results in lower ranging performance. In order to improve this problem, the receiving antenna is provided to be matched with the antenna modification structure 160 in this embodiment, therefore, the characteristic parameter of the receiving antenna can be adjusted through the antenna modification structure 160, such as changing a refractive index of the receiving antenna, thereby changing the position of the light spot of the receiving antenna and making the light spot of the receiving antenna approach the light spot of the transmitting antenna, thereby reducing the deviation angle between the light spot of the transmitting antenna and the light spot of the receiving antenna. In this embodiment, a light beam deflection angle corresponding to a light spot of an adjusted receiving antenna is α1′, and the deviation angle becomes δ″ at this time, δ=″|α1′−α2|, and δ″ is less than δ.

In an embodiment, in the lidar corresponding to FIG. 2 and FIG. 3, after the beam splitter 130 splits the emitted laser light beam to form the emitted laser light sub-beams, the electro-optic phase shifter(s) can be utilized to perform phase modulation to the emitted laser light sub-beam(s) corresponding to the transmitting antenna(s), so as to quickly complete the phase modulation to the light sub-beam(s), achieving fast scanning of light spot(s). And, during a process of receiving the echo signal(s), a thermo-optic phase shifter with low optical loss is utilized to perform phase modulation to a received echo signal, to reduce optical loss and achieve efficient reception of the echo signal.

In an embodiment, each transmitting antenna and each receiving antenna are respectively provided with one antenna modification structure 160;
a light spot of one transmitting antenna or a light spot of one receiving antenna in the phased-array antenna array 150 is used as a reference light spot, characteristic parameters of other receiving antennas and/or other transmitting antennas are adjusted by the antenna modification structure 160, so as to reduce a deviation angle between a light spot of an adjusted receiving antenna and/or an adjusted transmitting antenna and the reference light spot.

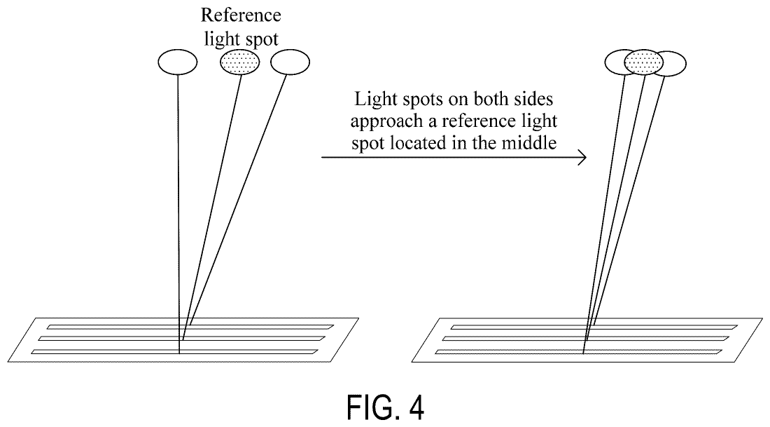

Please refer to FIG. 4, when a total number of the transmitting antenna(s) and the receiving antenna(s) in the phased-array antenna array 150 is greater than 2, a light spot located in the middle position can be selected as the reference light spot for the convenience of adjustment and alignment in an implementation. In addition, a light spot of a transmitting antenna can also be selected as the reference light spot. Specifically, when the light spot located in the middle position is selected as the reference light spot, the antenna modification structure 160 can be used to adjust the characteristic parameters of other antennas (i.e., transmitting antenna(s) and receiving antenna(s) other than the antenna corresponding to the reference light spot), so that light spots of other antennas move towards the reference light spot. For example, when a light beam deflection angle of one of the receiving antenna(s) is greater than a light beam deflection angle of a reference antenna (i.e., a transmitting antenna or a receiving antenna corresponding to the reference light spot), the antenna modification structure 160 can be utilized to heat this one receiving antenna to increase its refractive index, so that a light beam deflection angle of the heated receiving antenna decreases, thereby promoting a light spot of the heated receiving antenna to approach the reference light spot. For another example, when a light beam deflection angle of another receiving antenna is less than the light beam deflection angle of the reference antenna, the antenna modification structure 160 (such as a semiconductor chilling plate) can be utilized to cool down this receiving antenna to reduce its refractive index, so that a light beam deflection angle of the cooled-down receiving antenna increases, thereby promoting a light spot of the cooled-down receiving antenna to approach the reference light spot.

In order to simplify the complexity of the structural design of the lidar, in an embodiment, when each transmitting antenna and each receiving antenna are respectively provided with one antenna modification structure 160:
a light spot corresponding to a greatest light beam deflection angle is used as a reference light spot, characteristic parameters of transmitting antennas and/or receiving antennas corresponding to other light spots are adjusted by the antenna modification structure 160, so as to reduce a deviation angle between a light spot of an adjusted transmitting antenna and/or an adjusted receiving antenna and the reference light spot;
or, a light spot corresponding to a smallest light beam deflection angle is used as a reference light spot, characteristic parameters of transmitting antennas and/or receiving antennas corresponding to other light spots are adjusted by the antenna modification structure 160, so as to reduce a deviation angle between a light spot of an adjusted receiving antenna and/or an adjusted transmitting antenna and the reference light spot.

It can be understood that in general, a refractive index of an antenna increases as temperature increases, and a light beam deflection angle also decreases accordingly. Therefore, when the light spot corresponding to the smallest light beam deflection angle is used as the reference light spot, the antenna modification structure 160 can be utilized to heat the transmitting antennas and/or the receiving antennas corresponding to other light spots, so as to increase refractive indexes of the adjusted transmitting antenna and the adjusted receiving antenna, thereby reducing the deviation angles between the light spots of the adjusted transmitting antenna and the adjusted receiving antenna and the reference light spot. Similarly, when the greatest light beam deflection angle is used as the reference light spot, the antenna modification structure 160 can be utilized to cool down the transmitting antennas and/or the receiving antennas corresponding to other light spots, so that the beam deflection angles of both the adjusted transmitting antenna and the adjusted receiving antenna are increased, and based on a deviation angle between a light spot corresponding to a current transmitting/receiving antenna and the reference light spot, a to-be-adjusted temperature amplitude of the to-be-adjusted transmitting/receiving antenna can be estimated. Generally, when a deviation angle between a light spot corresponding to a current to-be-adjusted transmitting/receiving antenna and the reference light spot is large, a corresponding to-be-adjusted temperature amplitude is also relatively large. It should be noted in particular that, in this embodiment, “the light spot corresponding to the greatest light beam deflection angle” refers to a light spot with a maximum light beam deflection angle in the light spot(s) of the transmitting antenna(s) and the light spot(s) of the receiving antenna(s); “the light spot corresponding to the smallest light beam deflection angle” refers to a light spot with a smallest light beam deflection angle in the light spot(s) of the transmitting antenna(s) and the light spot(s) of the receiving antenna(s); “other light spots” refers to light spot(s) of transmitting antenna(s) and light spot(s) of receiving antenna(s) other than the above-described reference light spot.

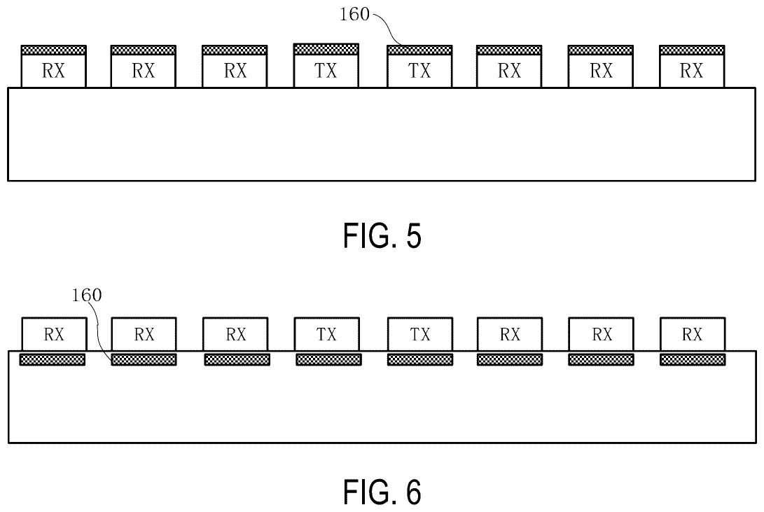

For example, in the lidar as shown in FIG. 5, the phased-array antenna array 150 includes 2 transmitting antennas and 4 receiving antennas, 6 light spots corresponding to them are not located in a same position; even light spots corresponding to any two of the transmitting antennas and the receiving antennas have a certain deviation angle there between, and the deviation angle is large. In order to obtain a better detection result, as many antennas as possible may be adjusted in practical applications, so it is usually necessary to configure a same type of antenna modification structure 160 for both the transmitting antenna(s) and the receiving antenna(s) to simplify the structural design and drive control. For example, thermo-optic modification structures are uniformly configured for the transmitting antenna(s) and the receiving antenna(s), the thermo-optic modification structures are utilized to respectively heat the transmitting antenna(s) and the receiving antenna(s) in different degrees, the beam deflection angle(s) of the transmitting antenna(s) and the receiving antenna(s) are uniformly reduced, so that the light spots of the transmitting antenna(s) and the receiving antenna(s) are offset towards a same direction, thereby reducing the deviation angles between the antennas. For another example, the antenna modification structures 160 with cooling effect are uniformly configured for the transmitting antenna(s) and the receiving antenna(s), to uniformly increase the beam deflection angles of the transmitting antenna(s) and the receiving antenna(s), so that the light spots of the adjusted transmitting antenna(s) and the adjusted receiving antenna(s) are offset towards a light spot corresponding to the greatest beam deflection angle.

In an embodiment, the antenna modification structure 160 may be any one of an electro-optic modification structure, a thermo-optic modification structure, an acousto-optic modification structure, and a micro-electro-mechanical modification structure.

It can be understood that when the antenna modification structure 160 is an electro-optic modification structure (such as an electro-optic phase shifter), by applying an voltage to its corresponding transmitting antenna(s)/receiving antenna(s) via the electro-optic modification structure, so that the refractive indexes of the transmitting antenna(s) and the receiving antenna(s) are changed based on an electro-optic effect, thereby changing the light beam deflection angles of the transmitting antenna(s) and the receiving antenna(s), and correspondingly changing the position(s) of the light spot(s). For example, when the electro-optic modification structure is used to adjust the transmitting antenna, the electro-optic modification structure can be placed above or/below the transmitting antenna, and then the electro-optic modification structure can apply an voltage to the antenna by setting electrodes on both sides of the transmitting antenna; when an imposed electric field changes, the electro-optic effect of the transmitting antenna will cause the refractive index of the transmitting antenna to change accordingly.

When the antenna modification structure 160 is a thermo-optic modification structure (such as a thermo-optic phase shifter), a phase of a light wave in a wave guide is changed by changing a refractive index of the wave guide according to a thermo-optic effect. Specifically, the thermo-optic phase shifter can be selected as a top heating type, that is, a heating electrode is placed above an antenna, and the heating electrode generates, by applying a bias current/voltage, heat and transfers the heat to the transmitting antenna/receiving antenna. Due to a high thermo-optic coefficient of silicon used for the manufacturing of the transmitting and receiving antennas, it is easy to change the refractive indexes of the transmitting and receiving antennas by heating, thereby changing the position(s) of the light spot(s). In addition, a double-sided heating type thermo-optic phase shifter can also be used as a thermo-optic modification structure. It should be noted that in this embodiment, there are no limitations on the materials of the heating electrode and a metal wire (used to introduce a bias current/voltage) in this embodiment, but generally resistivity of the heating electrode is about one order of magnitude higher than that of the metal wire to improve heating efficiency.

In addition, the antenna modification structure 160 can also be acousto-optic modification structure (such as an acousto-optic modulator), which is made using the acousto-optic effect of a medium. Its working principle is: when the modulated electrical signal changes, a piezoelectric crystal produces mechanical vibration to form ultrasonic waves due to the piezoelectric effect, the ultrasonic waves cause a density of an acousto-optic medium to change, resulting in a change in a refractive index of the medium. When a micro-electro-mechanical modification structure is used as the antenna modification structure to adjust the transmitting antenna(s) and/or receiving antenna(s), its working principle is to drive the transmitting antenna(s) and/or receiving antenna(s) to twist through a twisting driver based on MEMS (Micro-Electro-Mechanical System) technology, to achieve optical phase adjustment, thereby changing the position(s) of the light spot(s).

In an embodiment, each transmitting antenna and each receiving antenna are provided with one antenna modification structure 160; a transmitting antenna and/or a receiving antenna which needs to be adjusted is determined from the transmitting antenna(s) and the receiving antenna(s), the thermo-optic modification structure is utilized to adjust characteristic parameters of a determined transmitting antenna and/or a determined receiving antenna.

In this embodiment, the thermo-optic modification structure is utilized to modify all determined transmitting antenna(s) and receiving antenna(s), which can not only simplify the structural design and control complexity, but also be easy to implement. For example, in the above-described structure including 2 transmitting antennas and 6 receiving antennas, the light spot corresponding to the smallest light beam deflection angle is determined as the reference light spot, then for each one of other transmitting and receiving antennas, a deviation angle between its light spot and the reference spot is determined; then, it is determined whether an adjustment needs to be performed based on this deviation angle; if yes, the thermo-optic modification structure is utilized to heat and adjust the transmitting antenna/receiving antenna, so that a light spot of the adjusted transmitting antenna/receiving antenna approaches the reference light spot.

In an embodiment, the antenna modification structure 160 is located at bottom or top of the phased-array antenna array 150. Please continuing referring to FIG. 5, in the phased-array antenna array 150 as shown in FIG. 5, the antenna modification structures 160 are located above the transmitting antenna(s) and the receiving antenna(s), and each antenna modification structure 160 can be controlled separately. The antenna modification structures 160 can be manufactured by using transparent conductive materials (such as indium tin oxide) to form a transparent conductive film layer. However, when the antenna modification structure 160 is of a non-transparent structure and is located on one side of the light output direction of the phased-array antenna array 150, projections of the antenna modification structures 160 in a direction perpendicular to the optical chip does not overlap with projection of the phased-array antenna array in the direction perpendicular to the optical chip so as to avoid blocking an optical path. In addition, when the antenna modification structure 160 is of a non-transparent structure, it is provided to be below the corresponding transmitting antenna or receiving antenna (the emitted laser light beam is transmitted upward to the detection area through the transmitting antenna) in an embodiment, as shown in FIG. 6.

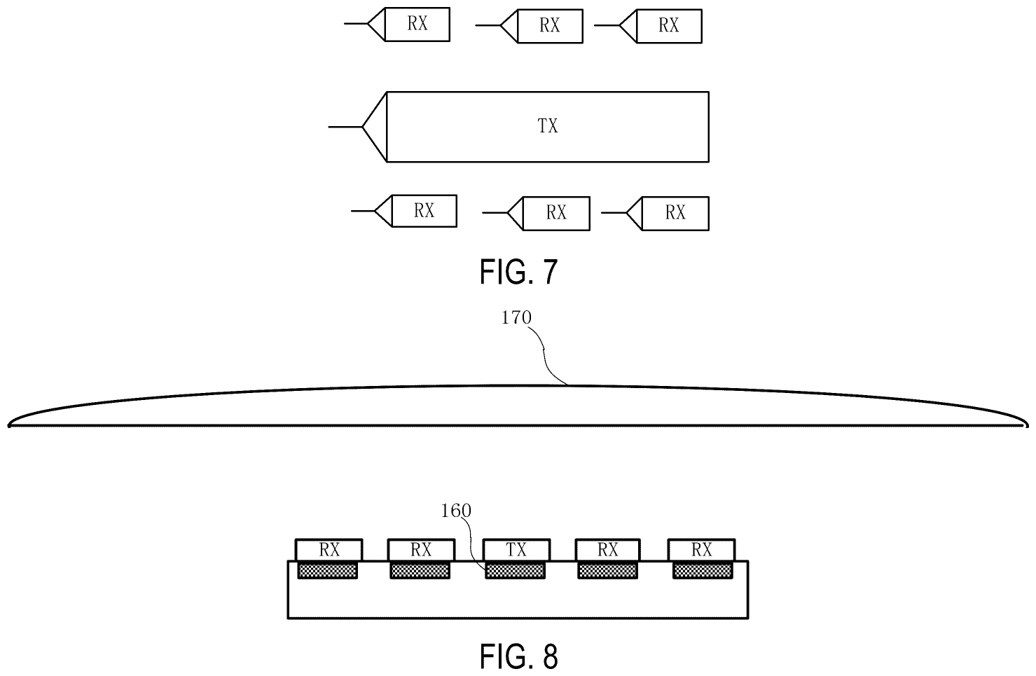

In an embodiment, when the phased-array antenna array 150 includes a plurality of the receiving antennas, the plurality of the receiving antennas are distributed on both sides of the transmitting antenna(s). Please refer to FIG. 4 to FIG. 7, the plurality of the receiving antennas RX are distributed on both sides of the transmitting antenna(s) TX to enhance signal reception. If the transmitting antenna(s) TX and the receiving antennas RX are the same in length, the receiving antennas will be arranged in sequence along a width direction of the transmitting antenna(s), as shown in FIG. 4 to FIG. 6; if the transmitting antenna(s) and the receiving antennas are different in length, the plurality of the receiving antennas located on the same side of the transmitting antenna(s) will be arranged in sequence along a length direction of the transmitting antenna(s), as shown in FIG. 7.

In an embodiment, the lidar further includes a lens module 170, where the lens module 170 is located at a light output side of the phased-array antenna array 150 and is configured to perform reshaping to the emitted laser light sub-beam(s) of the transmitting antenna(s), including performing collimation and beam expansion to the emitted laser light sub-beam(s) of the transmitting antenna(s), and perform converging to the echo signal to enlarge reception aperture(s) of the receiving antenna(s). As shown in FIG. 8, in this embodiment, the lens module includes a convex lens, where the convex lens is provided on a light output side of the phased-array antenna array 150. Through this convex lens, the emitted laser light sub-beam(s) can be converted into parallel lights; the emitted laser light sub-beam(s) is/are collimated and expanded, and emitted to the detection area; and, parallel echo signals will be converged through the convex lens, reducing a size of a light spot projected onto the phased-array to increase an effective aperture/effective apertures of the receiving antenna(s). In addition, the lens module can also be other types of lens or a combination of multiple lenses, and this embodiment does not impose any limitation on this.

Based on the same application concept, corresponding to the lidar provided by any above-described embodiment, an embodiment also provides a calibration method of a lidar, including following steps.
Step S301, providing an emitted laser light beam, and coupling the emitted laser light beam to an optical chip.
Step S302, splitting the emitted laser light beam to form an emitted laser light sub-beam.
Step S303, performing phase modulation to the emitted laser light sub-beam, and providing a phase-modulated emitted laser light sub-beam to a phased-array antenna array 150. Specifically, before transmitting the emitted laser light sub-beam to the detection area via the transmitting antenna, an electro-optic phase shifter can be utilized to perform phase modulation to the emitted laser light sub-beam, so as to achieve fast scanning of light spot. And, during a process of receiving the echo signal, a thermo-optic phase shifter with low optical loss is utilized to perform phase modulation to the received echo signal, which can reduce optical loss effectively and achieve efficient reception of the echo signal.
Step S304, transmitting, by a transmitting antenna in the phased-array antenna array 150, the phase-modulated emitted laser light sub-beam to a detection area; and, receiving, by a receiving antenna in the phased-array antenna array 150, an echo signal, where the echo signal is a light beam reflected by an object in the detection area after the object receives the emitted laser light sub-beam.
Step S305, utilizing an antenna modification structure 160 to adjust a characteristic parameter of the transmitting antenna and/or a characteristic parameter of the receiving antenna, so as to reduce a deviation angle between a transmitting light spot of at least one transmitting antenna and a receiving light spot of at least one receiving antenna; where the deviation angle is a difference between light beam deflection angles respectively corresponding to any two light spots of the transmitting light spot and the receiving light spot, and the light beam deflection angle is an angle formed between a light beam corresponding to a light spot and a plane of the optical chip.

In this embodiment, the phased-array antenna array 150 includes at least one transmitting antenna and at least one receiving antenna. The coupler 120, the beam splitter 130, the phase shifter 140, the phased-array antenna array 150 and the antenna modification structure 160 can be all integrated on the optical chip, where the coupler 120, the beam splitter 130, the phase shifter 140 and the phased-array antenna array 150 are connected in sequence through a wave guide, the antenna modification structure 160 is provided corresponding to the phased-array antenna array 150. During a working process of the lidar: the light source 110 is first utilized to generate the emitted laser light beam, and the emitted laser light beam is provided to the coupler 120 and is coupled, by the coupler 120, to the optical chip. Secondly, after beam splitting and phase modulation are performed in sequence to the emitted laser light beam, a phase-modulated emitted laser light sub-beam is transmitted, by the transmitting antenna in the phased-array antenna array 150, to a detection area, and, an echo signal is received by the receiving antenna in the phased-array antenna array 150; and then, according to positions of a light spot of the transmitting antenna and a light spot of the receiving antenna, the antenna modification structure 160 is utilized to adjust a characteristic parameter of the transmitting antenna and/or a characteristic parameter of the receiving antenna, so that a deviation angle between a light spot of at least one transmitting antenna and a light spot of at least one receiving antenna is reduced, ensuring that the light spot of the transmitting antenna and the light spot of the receiving antenna coincide as much as possible, so as to solve the problem of mismatch of the light spots caused by the characteristic parameter of the transmitting antenna being different from the characteristic parameter of the receiving antenna due to the manufacturing process, thereby improving the ranging performance of the lidar.

In an embodiment, after the characteristic parameter of the transmitting antenna and/or the characteristic parameter of the receiving antenna is adjusted, the deviation angle between the light spot of the transmitting antenna and the light spot of the receiving antenna is less than or equal to a preset threshold, to ensure that an object within a detection field can be detected. In practical applications, the preset threshold is not greater than 0.5°. It can be understood that when the deviation angle of the transmitting/receiving antenna is greater than 0.5°, an object with an ordinary size may not be detected. Therefore, to ensure that an object in the far field can be scanned, the preset threshold needs to be controlled within 0.5°. In an embodiment, the preset threshold can be set to no more than 0.1°, e.g. 0.03°, 0.01° or 0.005°.

To modify an antenna, one or more of the transmitting antenna(s) and the receiving antenna(s) can be selected according to actual needs, or only the transmitting antenna(s) or the receiving antenna(s) can be modified. Specifically, the method includes:
when the antenna modification structure 160 is provided to be matched with the transmitting antenna, utilizing the antenna modification structure 160 to adjust the characteristic parameter of the transmitting antenna, so as to reduce a deviation angle between a light spot of an adjusted transmitting antenna and the light spot of the at least one receiving antenna; or,
when the antenna modification structure 160 is provided to be matched with the receiving antenna, utilizing the antenna modification structure 160 to adjust the characteristic parameter of the receiving antenna, so as to reduce a deviation angle between a light spot of an adjusted receiving antenna and the light spot of the at least one transmitting antenna; or,
when each transmitting antenna and each receiving antenna are respectively provided with one antenna modification structure, using a light spot of one transmitting antenna or a light spot of one receiving antenna in the phased-array antenna array 150 as a reference light spot, utilizing the antenna modification structure 160 to adjust characteristic parameters of other transmitting antennas and/or other receiving antennas, so as to reduce a deviation angle between a light spot of an adjusted transmitting antenna and/or an adjusted receiving antenna and the reference light spot.

In an embodiment, a light spot corresponding to a greatest light beam deflection angle is used as a reference light spot, characteristic parameters of transmitting antennas and/or receiving antennas corresponding to other light spots are adjusted by the antenna modification structure 160, so as to reduce a deviation angle between a light spot of an adjusted transmitting antenna and/or an adjusted receiving antenna and the reference light spot; or, a light spot corresponding to a smallest light beam deflection angle is used as a reference light spot, characteristic parameters of transmitting antennas and/or receiving antennas corresponding to other light spots are adjusted by the antenna modification structure 160, so as to reduce a deviation angle between a light spot of an adjusted transmitting antenna and/or an adjusted receiving antenna and the reference light spot.

In an embodiment, the antenna modification structure 160 may be any one of an electro-optic modification structure, a thermo-optic modification structure, an acousto-optic modification structure, and a micro-electro-mechanical modification structure.

In an embodiment, according to the light beam deflection angle(s) corresponding to the light spot(s) of the transmitting antenna(s) and the light beam deflection angle(s) corresponding to the light spot(s) of the receiving antenna(s), a transmitting antenna and/or a receiving antenna which needs to be adjusted is determined from the transmitting antenna(s) and the receiving antenna(s); then, the thermo-optic modification structure is utilized to adjust characteristic parameters of a determined transmitting antenna and/or a determined receiving antenna.

The above descriptions are only exemplary embodiments of the present application and specifically describes the technical principles of the present application. These descriptions are only intended to explain the principles of the present application and cannot be interpreted in any way as limiting the protection scope of the present application. Based on the explanation here, any modifications, equivalent substitutions, and improvements made within the spirit and principles of the present application, as well as other specific embodiments of the present application that can be associated without creative efforts by those skilled in the art, shall be included in the protection scope of the present application.

What is claimed is:

1. A lidar, comprising:
a light source, configured to provide an emitted laser light beam;
a coupler, optically connected with the light source, and configured to couple the emitted laser light beam to an optical chip;
a beam splitter, optically connected with the coupler, and configured to split the emitted laser light beam to form an emitted laser light sub-beam;
a phase shifter, optically connected with the beam splitter, and configured to perform phase modulation to the emitted laser light sub-beam;
a phased-array antenna array, comprising at least one transmitting antenna and at least one receiving antenna, wherein the transmitting antenna and the receiving antenna are optically connected with the phase shifter one by one, the transmitting antenna is configured to transmit a phase-modulated emitted laser light sub-beam to a detection area, the receiving antenna is configured to receive an echo signal, the echo signal is a light beam reflected by an object in the detection area after the object receives the emitted laser light sub-beam; and
an antenna modification structure, provided corresponding to the phased-array antenna array, and configured to adjust a characteristic parameter of the transmitting antenna and/or a characteristic parameter of the receiving antenna, so as to reduce a deviation angle between a transmitting light spot of the at least one transmitting antenna and a receiving light spot of the at least one receiving antenna;
wherein the deviation angle is a difference between light beam deflection angles respectively corresponding to any two light spots of the transmitting light spot and the receiving light spot, and a light beam deflection angle is an angle formed between a light beam corresponding to a light spot and a plane of the optical chip.

2. The lidar according to claim 1, wherein after the characteristic parameter of the transmitting antenna and/or the characteristic parameter of the receiving antenna is adjusted, the deviation angle between the light spot of the transmitting antenna and the light spot of the receiving antenna is less than or equal to a preset threshold.

3. The lidar according to claim 2, wherein the preset threshold is not greater than 0.5°.

4. The lidar according to claim 1, wherein the antenna modification structure is provided to be matched with the transmitting antenna;
the characteristic parameter of the transmitting antenna is adjusted by the antenna modification structure, so as to reduce the deviation angle between the transmitting light spot of the adjusted transmitting antenna and the receiving light spot of the at least one receiving antenna.

5. The lidar according to claim 1, wherein the antenna modification structure is provided to be matched with the receiving antenna;
the characteristic parameter of the receiving antenna is adjusted by the antenna modification structure, so as to reduce the deviation angle between the receiving light spot of the adjusted receiving antenna and the transmitting light spot of the at least one transmitting antenna.

6. The lidar according to claim 1, wherein each transmitting antenna and each receiving antenna are respectively provided with one antenna modification structure;
a transmitting light spot of one transmitting antenna or a receiving light spot of one receiving antenna in the phased-array antenna array is used as a reference light spot, characteristic parameters of other receiving antennas and/or other transmitting antennas are adjusted by the antenna modification structure, so as to reduce a deviation angle between a receiving light spot of an adjusted receiving antenna and/or a transmitting light spot of an adjusted transmitting antenna and the reference light spot.

7. The lidar according to claim 1, wherein each transmitting antenna and each receiving antenna are respectively provided with one antenna modification structure;
a light spot corresponding to a greatest light beam deflection angle is used as a reference light spot, characteristic parameters of transmitting antennas and/or receiving antennas corresponding to other light spots are adjusted by the antenna modification structure, so as to reduce a deviation angle between a light spot of an adjusted transmitting antenna and/or an adjusted receiving antenna and the reference light spot; or
a light spot corresponding to a smallest light beam deflection angle is used as a reference light spot, characteristic parameters of transmitting antennas and/or receiving antennas corresponding to other light spots are adjusted by the antenna modification structure, so as to reduce a deviation angle between a light spot of an adjusted receiving antenna and/or an adjusted transmitting antenna and the reference light spot.

8. The lidar according to claim 1, wherein the antenna modification structure is any one of an electro-optic modification structure, a thermo-optic modification structure, an acousto-optic modification structure, and a micro-electro-mechanical modification structure.

9. The lidar according to claim 8, wherein each transmitting antenna and each receiving antenna are respectively provided with one antenna modification structure;
a transmitting antenna and/or a receiving antenna which needs to be adjusted is determined from the transmitting antenna and the receiving antenna, the thermo-optic modification structure is utilized to adjust a characteristic parameter of a determined transmitting antenna and/or a characteristic parameter of a determined receiving antenna.

10. The lidar according to claim 1, wherein the antenna modification structure is located at bottom or top of the phased-array antenna array.

11. The lidar according to claim 1, wherein when the phased-array antenna array comprises a plurality of receiving antennas, the plurality of receiving antennas are distributed on both sides of the transmitting antenna.

12. The lidar according to claim 1, further comprising:
a lens module, located at a light output side of the phased-array antenna array, and configured to perform collimation and beam expansion to the emitted laser light sub-beam of the transmitting antenna and perform converging to the echo signal.

13. The lidar according to claim 1, wherein the characteristic parameter of the transmitting antenna is at least one of a refractive index, carrier concentration, an antenna grating period, and a duty cycle of the transmitting antenna;
and/or,
the characteristic parameter of the receiving antenna is at least one of a refractive index, carrier concentration, an antenna grating period, and a duty cycle of the receiving antenna.

14. The lidar according to claim 1, wherein the beam splitter is an edge coupler, a Y-branch coupler, a directional coupler or a multi-mode interference coupler.

15. A calibration method of a lidar, comprising:
providing an emitted laser light beam, and coupling the emitted laser light beam to an optical chip;
splitting the emitted laser light beam to form an emitted laser light sub-beam;
performing phase modulation to the emitted laser light sub-beam, and providing a phase-modulated emitted laser light sub-beam to a phased-array antenna array;
transmitting, by a transmitting antenna in the phased-array antenna array, the phase-modulated emitted laser light sub-beam to a detection area; and, receiving, by a receiving antenna in the phased-array antenna array, an echo signal, wherein the echo signal is a light beam reflected by an object in the detection area after the object receives the emitted laser light sub-beam; and
utilizing an antenna modification structure to adjust a characteristic parameter of the transmitting antenna and/or a characteristic parameter of the receiving antenna, so as to reduce a deviation angle between a transmitting light spot of at least one transmitting antenna and a receiving light spot of at least one receiving antenna;
wherein the deviation angle is a difference between light beam deflection angles respectively corresponding to any two light spots of the transmitting light spot and the receiving light spot, and a light beam deflection angle is an angle formed between a light beam corresponding to a light spot and a plane of the optical chip.

16. The calibration method according to claim 15, further comprising:
when the antenna modification structure is provided to be matched with the transmitting antenna, utilizing the antenna modification structure to adjust the characteristic parameter of the transmitting antenna, so as to reduce the deviation angle between the transmitting light spot of the adjusted transmitting antenna and the receiving light spot of the at least one receiving antenna; or,
when the antenna modification structure is provided to be matched with the receiving antenna, utilizing the antenna modification structure to adjust the characteristic parameter of the receiving antenna, so as to reduce the deviation angle between the receiving light spot of the adjusted receiving antenna and the transmitting light spot of the at least one transmitting antenna; or,
when each transmitting antenna and each receiving antenna are respectively provided with one antenna modification structure, using a transmitting light spot of one transmitting antenna or a receiving light spot of one receiving antenna in the phased-array antenna array as a reference light spot, utilizing the antenna modification structure to adjust characteristic parameters of other transmitting antennas and/or other receiving antennas, so as to reduce a deviation angle between a light spot of an adjusted transmitting antenna and/or an adjusted receiving antenna and the reference light spot.

17. The calibration method according to claim 15, wherein each transmitting antenna and each receiving antenna are respectively provided with one antenna modification structure, the method further comprising:
using a light spot corresponding to a greatest light beam deflection angle as a reference light spot, adjusting, by the antenna modification structure, characteristic parameters of transmitting antennas and/or receiving antennas corresponding to other light spots, so as to reduce a deviation angle between a light spot of an adjusted transmitting antenna and/or an adjusted receiving antenna and the reference light spot; or
using a light spot corresponding to a smallest light beam deflection angle as a reference light spot, adjusting, by the antenna modification structure, characteristic parameters of transmitting antennas and/or receiving antennas corresponding to other light spots, so as to reduce a deviation angle between a light spot of an adjusted transmitting antenna and/or an adjusted receiving antenna and the reference light spot.

18. The calibration method according to claim 15, wherein the antenna modification structure is any one of an electro-optic modification structure, a thermo-optic modification structure, an acousto-optic modification structure, and a micro-electro-mechanical modification structure.

19. The calibration method according to claim 18, wherein each transmitting antenna and each receiving antenna are respectively provided with one antenna modification structure, the utilizing an antenna modification structure to adjust a characteristic parameter of the transmitting antenna and/or a characteristic parameter of the receiving antenna comprises:
determining a transmitting antenna and/or a receiving antenna which needs to be adjusted from the transmitting antenna and the receiving antenna according to the light beam deflection angle corresponding to the light spot of the transmitting antenna and the light beam deflection angle corresponding to the light spot of the receiving antenna;
utilizing the thermo-optic modification structure to adjust a characteristic parameter of a determined transmitting antenna and/or a characteristic parameter of a determined receiving antenna.

20. The method according to claim 15, wherein the utilizing an antenna modification structure to adjust a characteristic parameter of the transmitting antenna and/or a characteristic parameter of the receiving antenna comprises:
utilizing the antenna modification structure to adjust the characteristic parameter of the transmitting antenna or the characteristic parameter of the receiving antenna respectively;
or,
utilizing the antenna modification structure to synchronously adjust the characteristic parameter of the transmitting antenna and the characteristic parameter of the receiving antenna.
